(19) United States
(12) Patent Application Publication
(10) Pub. No.: US 2024/0014706 A1
(43) Pub. Date: Jan. 11, 2024

(54) ELECTRIC MOTOR FOR AN ACTUATING DEVICE OF A MOTOR VEHICLE AND METHOD FOR MOUNTING A CAMSHAFT ADJUSTER

(71) Applicant: Schaeffler Technologies AG & Co. KG, Herzogenaurach (DE)

(72) Inventors: Sandro Lauer, Baiersdorf (DE); Joachim Meyer, Nürnberg (DE); Friedrich Schuler, Wilhelmsdorf (DE)

(73) Assignee: Schaeffler Technologies AG & Co. KG, Herzogenaurach (DE)

(21) Appl. No.: 18/038,475

(22) PCT Filed: Nov. 25, 2021
(86) PCT No.: PCT/DE2021/100933

§ 371 Date: May 24, 2023

(30) Foreign Application Priority Data
Nov. 26, 2020 (DE) 10 2020 131 326.8

(51) Int. Cl. H02K 5/22; H02K 5/02; H02K 5/18; H02K 7/14

(52) U.S. Cl. CPC H02K 5/225; H02K 5/02; H02K 5/18; H02K 7/14; H02K 2205/09; H02K 2211/03

(57) ABSTRACT

The disclosure relates to an electric motor for driving an actuating device of a motor vehicle, comprising a housing, a plug module, which has a first plug connector, and a screw, by which the plug module is screwed to the housing. The plug modules forms a housing flange and the screw is arranged completely within the interior space enclosed by the housing and the plug module. The disclosure also relates to a method for connecting a camshaft adjuster to such an electric motor.

### CROSS-REFERENCE TO RELATED APPLICATIONS

This application is the U.S. National Phase of PCT Application No. PCT/DE2021/100933 filed on Nov. 25, 2021, which claims priority to DE 10 2020 131 326.8 filed on Nov. 26, 2020, the entire disclosures of which are incorporated by reference herein.

### TECHNICAL FIELD

The disclosure relates to an electric motor for driving an actuating device of a motor vehicle. Furthermore, the disclosure relates to a method for connecting such an electric motor as part of a camshaft adjuster.

### BACKGROUND

Electric motors that have housings specially adapted for application in motor vehicles are used, for example, in electromechanical camshaft adjusters for internal combustion engines, where they serve as actuators for adjusting the adjusting shaft of a transmission connected to the camshaft. In addition to a stator and a rotor as a motor in the narrower sense, such electric motors usually have a circuit board, power electronics, and a housing. The housing seals the electric motor against oil from the chain housing and can serve as a fixed bearing. A flange attached to the housing often represents the fastening interface to the cylinder head cover of the combustion engine. This connection to the cylinder head cover must be oil-tight. For this purpose, it is known to use sheet steel flanges that are connected, for example, via a laser weld seam to achieve the required tight fit and the required sealing tightness. To ensure corrosion resistance of the housing with the sheet steel flange to environmental influences in the engine compartment, the two components are usually coated. However, laser welding cannot be used on coated components, and subsequent coating of the assembly is expensive.

A molded plastic flange is provided in DE 10 2011 080 265 A1 to solve the problem. However, it has been found that the plastic-metal composite does not have the required sealing tightness over the entire temperature window in the operating range. Furthermore, the use of plastic over a large area does not sufficiently close the magnetic circuit, so that additional EMC measures may be necessary.

DE 10 2005 023 202 A1 provides a joint between a plastic flange and a sheet metal housing for an electric motor of a camshaft adjuster. For this purpose, the two components are screwed together. Here, too, it has been found that sealing tightness cannot be guaranteed within the required temperature window over the service life, since the plastic settles and relaxes with the high temperature fluctuations. This leads to a loss of the screw preload force and, as a result, to leakage of the housing. The power electronics and the printed circuit board are then exposed to aggressive substances in the engine oil. It is also necessary to coat the screws so that they do not corrode. Ultimately, assembly is complex.

Other electric motors for actuating devices of a motor vehicle are known from DE 10 2014 213 324 A1, DE 10 2015 122 342 A1, DE 11 2017 001 187 T5, DE 10 2017 214 774 A1, DE 11 2018 004 990 T5, DE 10 2017 111 922 A1 DE 10 2013 212 933 B3, U.S. Pat. No. 8,220,426 B2, and U.S. Pat. No. 10,389,212 B2.

### SUMMARY

The disclosure is based on the object of creating an electric motor for an actuator of a motor vehicle which does not have the disadvantages mentioned above. The increasing compaction of components in the engine compartment of motor vehicles also requires that the housing, together with the power supply thereof, requires as little axial space as possible and is nevertheless easy to assemble. Furthermore, the disclosure is based on the object of demonstrating an assembly method for an electric camshaft adjuster.

The first part of the object is achieved by an electric motor described herein; the second part of the object is achieved by a method described herein.

The electric motor then has a housing base body and a plug module. The two components, the housing base body and the plug module, together or with one or more other components, form the housing of the electric motor, which encloses an interior space that is sealed against external environmental influences on the other side of the housing. The housing base body and the plug module are screwed together by a screw. The screw is located entirely within the interior space and is used to attach the plug module to the housing base body. This means that the screw does not penetrate the housing from the outside, so it is not exposed to external environmental influences and therefore does not corrode. In particular, a coating of the screw can thus be dispensed with.

Even if the basic housing base body forms only a part of the outer wall and thus a partial housing of the electric motor, it is desirable to form and maximize this part of the housing from metal so that a large surface area of the outer wall is available for heat dissipation in the interior space due to friction losses and losses in the heat resulting from the power electronics can be used. For this purpose, the basic housing base body can be pot-shaped and have only one opening, for example in a side wall, for the plug module.

It is advantageous if the housing has cooling ribs to maximize the surface area. In one embodiment, the housing is made of aluminum, for example as an aluminum die-cast housing.

The plug module has a plug connector. The plug connector is used to connect a line, such as an electrical line for the operation of the electric motor. The plug connector can form an interface for form-fitting connection with a mating plug connector. The mating plug connector is can be a plug which can be fixed to the plug module in a force-fitting, detachable manner by means of spring force. In principle, the plug connector can be designed as a male or female part of the plug connector. It can also be designed as a socket in the plug module. In an alternative embodiment, the plug connector is designed as a flat plug connector like a cable lug. To additionally secure the plug connection, mechanical locks such as a bayonet lock, clamp mechanisms or spring locks can be provided on the plug connector.

The plug module can have multiple plug connectors. These can differ in their type, as previously discussed. They can also have a different geometry, for example to rule out incorrect assembly or to satisfy different current intensities to be transmitted. Furthermore, they can also be intended for different types of lines, for example to enable the connection to an optical-based communication network in the vehicle via an optical fiber.

Each plug connector can have one, two, or more contacts. It is provided in one embodiment that it is provided with a large number of contacts to be able to transmit the required current intensities safely, but with a plug contact. The control signal required for the motor can be modulated or transmitted via a separate contact. The plug connector can have an asymmetrical shape to force the mating plug connector to be connected with polarity reversal during assembly. To expose the contact points to only small vibrations and forces, strain relief means can be provided.

The plug module can be made of plastic. When installed in the electric motor, it has the plug connector pointing outwards. In this case, plug connectors designed as sockets can be produced in one piece with the plug module. For example, the plug module is manufactured using an injection molding process.

Production is particularly simple if the plug module is designed as an essentially planar flange with two end faces. Alternatively, it can be a component with a complex shape that combines as many functions as possible, such as the connection contact for the electric motor, the fastening for the screw, communication lines, seals, or pressure compensating elements.

In one embodiment, the plug module has soldering lugs, welding lugs, or press-in contacts connected to the plug connection contacts on the side thereof facing the interior space. This can be used to establish an electrical connection with a printed circuit board arranged in the interior space, a sensor system for the electric motor, or with a motor winding of the electric motor.

In a further embodiment, the plug module has mechanical connecting means, with which the plug module is held, for example, on the housing base body in addition to the screw connection. These can be used to pre-position the plug module. The mechanical connecting means can in particular be designed as clamping lugs or as one or more clamping ribs. Additionally or alternatively, a seal can be arranged between the housing base body and the plug module. The assembly of the seal is particularly easy if it is pre-assembled on the plug module. For this purpose, for example, an O-ring can be placed in a groove on the plug.

If the plug module has two end faces, the plug connectors extend outwards from the first end face and have a receiving means for the screw on the other end face directed toward the interior space. The receiving means can be designed as a blind hole arranged in the plug module or as a through-recess. In both cases it can have a thread for the screw. However, it is also conceivable that the screw is screwed into the material of the plug module.

For example, a plug module designed as a flange has a bead as a thickened material on the end face thereof directed toward the interior space, into which the receiving means is introduced. This has the advantage that the material required for the screw connection can be provided in a suitable thickness at this point. The flange width can therefore not only be reduced by the width of the screw head, but by a multiple, because the required forces can be safely absorbed in the bead and no distances between the screw connection and the plug connectors need to be taken into account. It is therefore conceivable that the width of the panel only slightly exceeds that of the plug connection, in particular by less than two or one screw head width. The plug module thus has a small surface area and is compact due to the lack of screw connections on the front side.

In one embodiment, the screw connects the plug module to the housing base body. A plurality of screws, in particular two, can be provided to achieve a uniform attachment. The screw can be designed as a self-tapping screw, so that it forms its own mating thread in the plug module. This direct screw connection means that a pre-formed thread is not required either in the plug module or in the housing base body.

In an example embodiment, the housing base body has no bore for the screw. This means that not only the thread, but also the post-processing of the housing base body by machining can be omitted. A corresponding recess for the screw can be provided during the casting process, so that no additional work is required. Alternatively, no recess is provided, but the housing base body has tabs or projections on which the screw head can be supported.

In a next further development, the screw connection is free of plastic. This means that the screw head rests on metal and not plastic. In particular, the screw head rests directly on the aforementioned lugs, projections, or recesses of the housing base body and is screwed into the plastic of the plug module. This ensures that no setting takes place. At high temperature, there is no loss of pre-load due to creep and relaxation because there is no plastic between the screw head and the bearing surface thereof.

In one embodiment of the disclosure, the electric motor has an electric motor shaft as the output shaft thereof, wherein the screw is screwed in parallel to the electric motor shaft. The electric motor shaft can form the input shaft of a transmission that is downstream in the flow of torque, wherein the transmission must be attached to the electric motor. For example, the electric motor/gear unit is an electric camshaft adjuster having a harmonic, planetary, or other three-shaft gear. The respective transmission output side is non-rotatably connected to a central screw on the camshaft of an internal combustion engine, wherein the main transmission axis and the central screw run parallel to the electric motor shaft. In such a unit, the screw and the central screw also run parallel. The fact that the screwing direction is the same not only simplifies assembly, because all components are assembled in the same direction, the main assembly direction. Furthermore, the same installation space can be used for the tools during assembly. This is advantageous because the installation space can be used for other purposes after assembly. If the plug contact is also angled towards the screwing direction, a plug can be connected to the side of the plug module, so that the housing can be closed by a cover directly behind the screw head as seen in the screwing direction. Contacting the cables at the side shortens the axial length of the overall system, so that the electric motor can be arranged closer to a vehicle body if necessary.

On the end face thereof directed toward the interior space, the plug module can have one or more contacts that serve to supply power to the electric motor or to communicate with a control unit. The contacts can be offset inwards from the edges of the plug module in relation to the plug connections pointing outwards. This creates lateral space for fastening the plug module, for example for the aforementioned arrangement of a bead with a blind hole, without increasing the width of the plug module over the width of the plug connector(s).

In a further embodiment, the plug module has a pressure compensating element. For this purpose, a membrane can be embedded in the material of the plug module. The positive or negative pressure generated by the enclosed air in the interior space as a result of the changing operating temperatures can thus be equalized.

The electric motor can be used to drive an actuating device in a motor vehicle. For example, it can be part of an electric camshaft adjuster or a device for changing the compression ratio.

The disclosure also relates to a method for connecting a camshaft adjuster to an electric motor and a transmission on an internal combustion engine having a camshaft, wherein the transmission is screwed to the camshaft with a central screw and the plug module is screwed to the housing. Both screwing processes take place in the same direction. This simplifies assembly, and the lateral installation space required for assembly is reduced.

### BRIEF DESCRIPTION OF THE DRAWINGS

An exemplary embodiment of the disclosure is shown in the figures. In the figures:

FIG. 1 shows a schematic representation of an electric motor according to the prior art in a perspective view,

FIG. 2 shows a schematic representation of an electric motor according to the disclosure in a perspective view,

FIG. 3 shows a top view of the electric motor according to FIG. 2 from the perspective of the electric motor shaft having a housing base body and a plug module,

FIG. 4 shows an enlarged longitudinal section through the connection of the housing base body with the plug module according to FIG. 3, and

FIG. 5 shows an enlarged perspective view of the plug module from FIG. 3.

### DETAILED DESCRIPTION

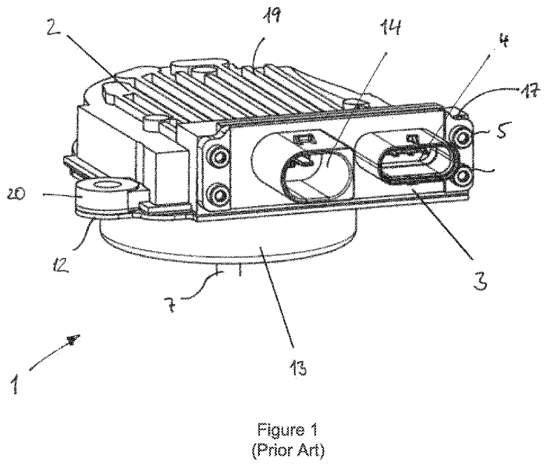

FIG. 1 shows an external view of an electric motor 1 having an electric motor shaft 7 according to the prior art. The electric motor 1 has a pot-shaped housing base body 2, which can be made of die-cast aluminum, for example, and has cooling ribs 19 in the present case. The basic housing base body 2 is sealed off from the electric motor shaft 7 by a flange 12 and a stator housing 13, so that only one opening remains on an end face 17, which is directed forward in FIG. 1. The flange 12 is, for example, screwed to the housing base body 2 in the direction of the electric motor shaft 7.

The opening is closed by a plug module 3, so that a closed interior space 6, not shown in FIG. 1, is formed. The plug module 3 is designed as a panel and can be made of plastic. It is fastened directly to the housing base body 2 by means of four screws 5. The four screws 5 are arranged in pairs on the outside and penetrate the plug module 3. They are screwed to the electric motor shaft 7 at an angle of 90°. The plug module 3 has a first plug connector 4 and a second plug connector 14, which can form an electrical contact by means of mating plug connectors, not shown.

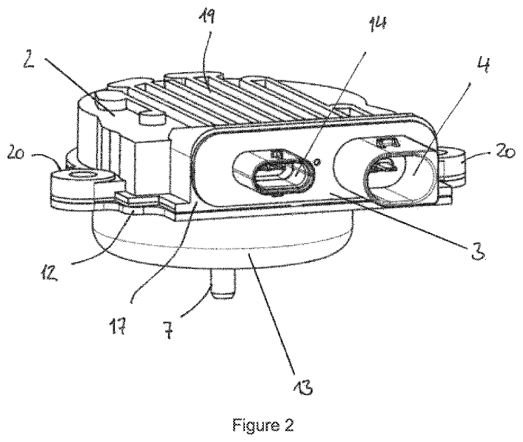

FIG. 2 shows an electric motor 1 having a motor assembly that is unchanged compared to FIG. 1. The housing base body 2 therefore has similar dimensions, which differ only in the connection region of the plug module 3. As can be seen immediately, the plug module 3 is not penetrated by screws 5 on the outside. Since the screws 5 are arranged in the interior space, they do not penetrate the plug module 3 on the outside. They therefore neither come into contact with engine oil nor are they exposed to the air of the external environment, so that the screws 5 are protected from corrosion.

In comparison to the plug module 3 according to FIG. 1, the plug module 3 according to FIG. 2 can be designed to be narrower because no material is required on the end face on which the screws 5 need to be supported. As a result, the housing base body 2 adjoining at the rear can also be made narrower, which makes it lighter.

The plug module 3 has two geometrically different plug connectors 4, 14. This rules out an incorrect installation of cables.

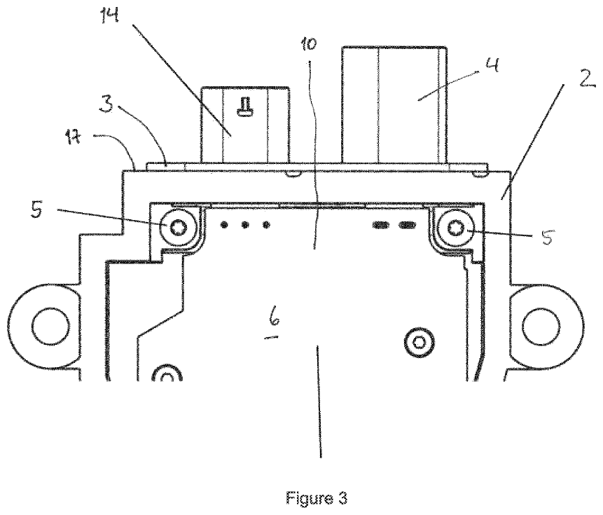

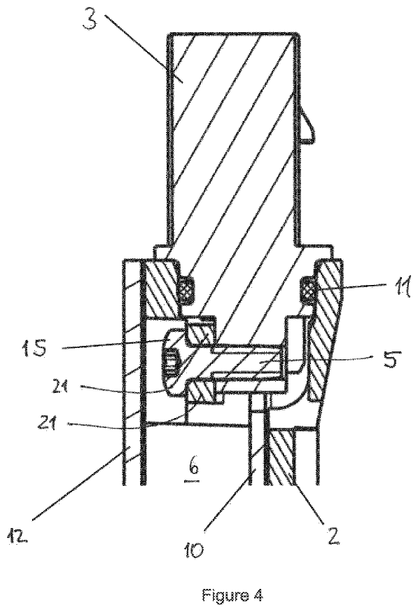

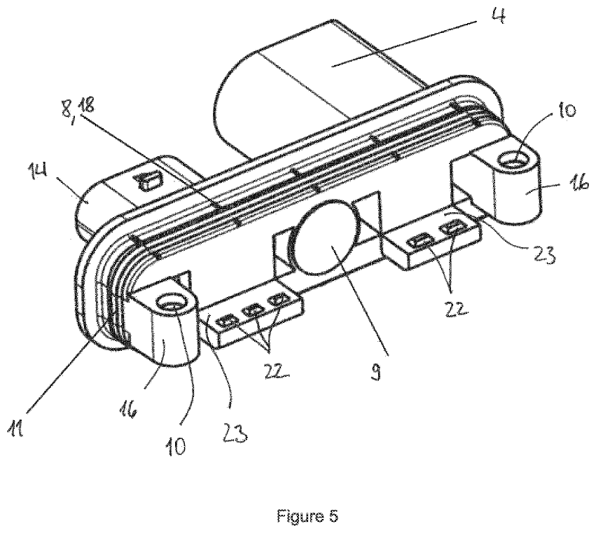

It can be seen from FIGS. 3 and 4 how the plug module 3 is screwed to the housing base body 2. For this purpose, the plug module 3 has two bead-like projections 16 with a receiving means 10 for one screw 5 each on the side thereof facing the housing base body 2. As can be seen from FIG. 5, the projections 16 extend over almost more than half the height of the plug module 3, so that the screws 5 can have a shank length sufficient for a secure connection. The receiving means 10 is threadless, so that it can be produced in a simple manner during the primary shaping if the plug module is produced as an injection molded part. The screws 5 are thread-forming, so that the mating thread is formed in the receiving means 10 when they are screwed together. The receiving means 10 are offset by 90° to the plug connectors 4, 14 and directed to be parallel to the electric motor shaft 7. They are thus screwed in the same axial direction as the electric motor 1 with the gear thereof, not shown. This has the advantage, particularly when assembling the actuating devices in modern internal combustion engines, that the plug connector outlet can be directed laterally without having to provide space for the assembly tool there. In the case of pre-assembly, there is the advantage that the cycle time can be reduced or the assembly device can be made simpler, since all screwing operations take place in one direction, namely the main assembly direction. A further advantage of this arrangement is that the width of the plug module 3 can be reduced because no recesses for the screws 5 need be provided on the face side. The plug connectors 4, 14 can thus move further to the edge of the plug module 3. In the present case, the screws 5 screw heads 15 have a screw head diameter s, and the distance d between the plug connector 4, 14 and the respective outer edge of the plug module 3 is smaller than twice the screw head diameter s. It can also be smaller than the screw head diameter s. In this case, the projections 16 should be correspondingly narrow, or the plug connectors 4, 14 are contacted in the interior space 6 in each case offset inwards to create space for the projections 16.

After the pre-assembly of the components to be arranged in the interior space 6 and the plug module 3, the flange 12 can also be screwed to the stator housing 13. For this purpose, 2 lugs 20 are provided on the side of the housing base body. These can be shaped like perforated discs and can therefore be used for screwing, again in the main assembly direction. In this way, both the screws 5 and the screws that fasten the flange 12 to the housing base body 2 are screwed in the same direction, here parallel to the electric motor shaft 7.

FIG. 4 shows that the housing base body 2 has internal projections 21 with a through-recess for the screws 5. The inner projections 21 can be introduced during the production of the housing base body 2, for example during primary shaping, and serve as a contact surface for the screw head 15 of the screw 5. Therefore, there is no plastic between the metallic screw head 15 and the likewise metallic contact surface of the inner projections 21, in particular not the plug module 3. This ensures that settling and loss of prestressing due to creep and relaxation of the plastic at high temperatures is avoided.

A circuit board 10 for the electric motor 1 is arranged in the interior space 6. As can be seen from FIG. 5, the printed circuit board 10 is supplied with the signals or currents introduced via the plug connectors 4, 14 by contacts 22 arranged on the plug module 3. The contacts 22 are arranged on two different shoulders 23 flanking the projections 16.

The plug module 3 has clamping ribs 8, via which it can be temporarily fixed in the housing base body 2 before it is screwed. A sealing ring 11 in the form of an O-ring is arranged between the clamping ribs 8 so that the interior space 6 is sealed against environmental influences. The sealing ring 11 is pre-assembled in a groove, not shown.

Due to the sealing and the unavoidable inclusion of air, the electric motor requires pressure compensation in the interior space 6 to be able to satisfy the temperature conditions, which potentially differ by more than 100 K. For this purpose, the plug module has a pressure compensating membrane 9 between the shoulders 23.

### LIST OF REFERENCE SYMBOLS

1 Electric motor
2 Housing base body
3 Plug module
4 First plug connector
5 Screw
6 Interior space
7 Electric motor shaft
8 Clamping rib
9 Pressure compensating membrane
10 Printed circuit board
11 Sealing ring
12 Flange
13 Stator housing
14 Second plug connector
15 Screw head
16 Projection
17 End face
18 Clamping rib
19 Cooling rib
20 Lug
21 Inner projection
22 Contact
23 Shoulder
d Distance
s Screw head diameter

1. An electric motor for driving an actuating device of a motor vehicle, the electric motor comprising:
a housing having a housing base body,
a plug module: i) forming a housing wall of the housing, ii) together with the housing base body, encloses an interior space, and iii) having a plug connector arranged outside the interior space, and
a screw having a screw head, the screw head configured to fasten the plug module to the housing base body,
wherein
the screw is arranged completely inside the interior space.

2. The electric motor according to claim 1, wherein the electric motor has an electric motor shaft, in an axial direction of which the screw is screwed.

3. The electric motor according to claim 1, wherein the plug module has a clamping rib.

4. The electric motor according to claim 1, wherein the plug module has a pressure compensating membrane.

5. The electric motor according to claim 1, wherein the screw has a screw head with a screw head diameter and that a distance between a plug connector and an outer edge of the plug module is smaller than twice the screw head diameter.

6. The electric motor according to claim 1, wherein the plug module is made of plastic and includes an unthreaded receiving means for the screw configured as a thread-forming screw.

7. The electric motor according to claim 6, wherein the housing base body is made of metal and has a through-recess delimited by an edge for the screw and the screw head rests on the edged so that a connection formed between the screw head and housing base body is free of plastic.

8. The electric motor according to claim 1, wherein the plug module makes electrical contact with a printed circuit board in the interior space.

9. A method for installing a camshaft adjuster having the electric motor of claim 1, the electric motor configured for driving a transmission of a camshaft of an internal combustion engine, the method comprising:
screwing the transmission to the camshaft with a central screw, and
screwing the plug module to the housing base body, wherein the plug module is screwed to the housing base body in a same direction as a screwing direction of the central screw.

10. The method according to claim 9, wherein the plug module has a clamping rib via which the plug module is pre-fixed to the housing base body before the plug module is screwed to the housing base body.

11. The method of claim 9, wherein the plug module has a pressure compensating membrane.

12. An electric motor for driving an actuating device of a motor vehicle, the electric motor comprising:
a housing having a housing base body,
a plug module: i) forming a housing wall of the housing, ii) together with the housing base body, encloses an interior space, and iii) having a plug connector arranged outside the interior space, and
a screw configured to fasten the plug module to the housing base body,
wherein the screw is arranged completely inside the interior space.

13. The electric motor of claim 12, wherein the plug module further comprises a projection configured to receive the screw.

14. The electric motor of claim 13, wherein the projection is threadless.

15. The electric motor of claim 12, wherein the plug module has a pressure compensating membrane.

16. An electric motor for driving a transmission of a camshaft adjuster of an internal combustion engine, the electric motor comprising:
a stator housing,
a housing having a housing base body fastened to the stator housing,
a plug module: i) forming a housing wall of the housing, ii) together with the housing base body, encloses an interior space, and iii) having a plug connector arranged outside the interior space,
a screw configured to fasten the plug module to the housing base body,
wherein the screw is arranged completely inside the interior space.

17. The electric motor of claim 16, wherein the housing base body is sealed from an electric motor shaft via the stator housing.

18. The electric motor of claim 16, further comprising a circuit board disposed within the interior space, and the plug module is configured to electrically contact the circuit board.

19. The electric motor of claim 16, wherein the housing base body further comprises cooling ribs.
